(19) United States
(12) Patent Application Publication
(10) Pub. No.: US 2006/0039409 A1
(43) Pub. Date: Feb. 23, 2006

(54) Code domain bit interleaving and reordering in DS-CDMA MIMO

(76) Inventor: Marko Lampinen, Oulu (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(21) Appl. No.: 10/921,773

(22) Filed: Aug. 18, 2004

(51) Int. Cl. H04J 3/24

(52) U.S. Cl. 370/474

(57) ABSTRACT

A method for use in channel coding for cellular communication in case of a transmitter using a plurality of antennas to convey respective low-rate data streams each of which is modulated by a plurality of spreading codes so as to provide a respective plurality of code channels—some of which are “reused” (i.e. used by more than one of the antennas)—and which in combination convey a single (high-rate) data stream including both systematic bits (i.e. information bits, as opposed to redundancy or parity bits added to protect the information bits), and also redundancy bits, the method including a step of allocating the systematic and redundancy bits to the plurality of code channels so as to take into account differences in the quality of the different physical channels by using a bit allocation rule that allocates more systematic bits to non-reused code channels than to reused code channels.

### TECHNICAL FIELD

The present invention pertains to the field of cellular communication. More particularly, the present invention pertains to MIMO processing in DS-CDMA.

### BACKGROUND ART

It is known that under suitable channel fading conditions, having both multiple transmit and multiple receive antennas—i.e., a MIMO (multiple input multiple output) channel—provides additional spatial dimensions for communication.

In a DS-CDMA (Direct Sequence—Code Division Multiple Access) communication system, orthogonal codes are used in order to arrange that a single carrier provides multiple access. In a MIMO 3GPP (Third Generation Partnership Project) transmission, a single (high-rate) stream is transmitted as a plurality of low-rate streams each using codes from a same set of codes in the HS-DSCH (High Speed-Downlink Shared Channel) and some of the codes are possibly also used—i.e. “reused”—by more than one antenna (but not others of the codes). In some such transmissions, the SINR (signal to interference plus noise ratio) for each code (and so the corresponding so-called code channel) of the HS-DSCH channel may differ.

What is needed is a way of taking this difference into account, and preferably in a way that is of use not only in a telecommunication per 3GPPP, but in any cellular telecommunication system having MIMO DS-CDMA functionality.

### DISCLOSURE OF THE INVENTION

Accordingly, in a first aspect of the invention, a method is provided comprising: a step in which channel coding is performed for communication of systematic bits via a communication channel of a cellular communication system, the channel coding providing a stream of coded bits including both the systematic bits and also redundancy bits; and a step of allocating the systematic and redundancy bits to a plurality of code channels including both reused and non-reused code channels, each code channel corresponding to a different physical channel; wherein the bit allocation takes into account differences in the quality of the different physical channels by using a bit allocation rule that allocates more systematic bits to non-reused code channels than to reused code channels.

In accord with the first aspect of the invention, the stream for which the channel coding is performed may be a stream in a plurality of streams that in combination convey a single higher-rate data stream, and the bit allocation may be performed for each of the streams in the plurality of streams. Further, the bit allocation may provide bits for code channels in the plurality of code channels not reused by any of the streams, and for code channels in the plurality of code channels reused by two of the streams, and for code channels reused by three of the streams, and so on.

Also in accord with the first aspect of the invention, the method may further comprise a physical layer HARQ processing step subsequent to the step of channel coding, and the differences may be taken into account in the physical layer HARQ processing step.

Also in accord with the first aspect of the invention, the method may further comprise an interleaving step subsequent to the step of channel coding, and the differences may be taken into account in the interleaving step.

Also in accord with the first aspect of the invention, the method may further comprise a physical channel segmentation step subsequent to the step of channel coding, and the differences may be taken into account in the physical channel segmentation step.

Also in accord with the first aspect of the invention, if there are more systematic bits than can be allocated to non-reused code channels so that non-allocated systematic bits remain after allocating as many of the systematic bits as possible to non-reused code channels, the rule may allocate as many of the non-allocated systematic bits to the reused code channel expected to have the highest channel quality of the reused code channels.

In a second aspect of the invention, a computer program product is provided comprising a computer readable storage structure embodying computer program code thereon for execution by a computer processor, wherein the computer program code comprises instructions for performing a method according to the first aspect of the invention.

In a third aspect of the invention, an apparatus is provided comprising means for performing the steps of a method according to the first aspect of the invention.

In a fourth aspect of the invention, a user equipment terminal is provided having a transceiver for coupling the user equipment terminal to a radio access network, and including an apparatus comprising means for performing the steps of a method according to the first aspect of the invention.

In a fifth aspect of the invention, a network element is provided serving as at least part of a service access point of a radio access network, and including an apparatus comprising means for performing the steps of a method according to the first aspect of the invention.

In a sixth aspect of the invention, a system is provided, comprising: a radio access network including: network element serving as at least a part of a service access point of the radio access network, for providing a cellular communication signal; and a plurality of user equipment terminals each responsive to at least a portion of the cellular communication signal, wherein at least one of either the network element or one or more of the user equipment terminals includes an apparatus according to the third aspect of the invention.

### BRIEF DESCRIPTION OF THE DRAWINGS

The above and other objects, features and advantages of the invention will become apparent from a consideration of the subsequent detailed description presented in connection with accompanying drawings, in which:

FIG. 1 is a block diagram/flow diagram illustrating channel coding for cellular communication such as used in providing an HS-DSCH signal.

FIG. 2 is a block diagram/flow diagram for a HARQ bit collector according to the prior art.

FIGS. 3A and 3B are block diagrams/flow diagrams illustrating signal processing for a MIMO transmission.

FIGS. 4A and 4B is a block diagram/flow diagram of a HARQ bit collector modified according to the invention, allocating bits to code channels.

FIG. 5 is a schematic illustrating codes being used for two different data streams, one including codes not being reused, and the other only reused codes.

FIG. 6 is a block diagram/flow diagram for allocating bits to code channels, according to the invention, using a channel segmentation module of an (overall) channel coding chain.

FIG. 7 is a block diagram/flow diagram for allocating bits to code channels, according to the invention, using an interleaver module of an (overall) channel coding chain.

FIG. 8 is a flow diagram of a method, according to the invention, for allocating bits to code channels.

FIG. 9 is a block diagram of a telecommunication system including a user equipment terminal and a Node B network element, both of which can be provided so as to implement the invention.

### DETAILED DESCRIPTION OF THE INVENTION

The invention is here described in case of communication of a MIMO transmission via HS-DSCH of a 3GPP cellular telecommunication system. It should be understood however that the invention is of use in case of a multi-streaming MIMO transmission communication via a communication channel of any cellular communication system having MIMO DS-CDMA functionality.

As already specified (in 3GPP TS25.212 v.5.4.0 2003-03) for single input single output (SISO) transmission in HS-DSCH, the systematic bits in a turbo code may be assigned/allocated to more reliable locations in a 16-QAM constellation. In addition, the bit allocation may be rotated during a HARQ (hybrid automatic repeat request) process in case of failed packets. The invention uses these ideas in a MIMO transmission in an unbalanced code re-use scenario.

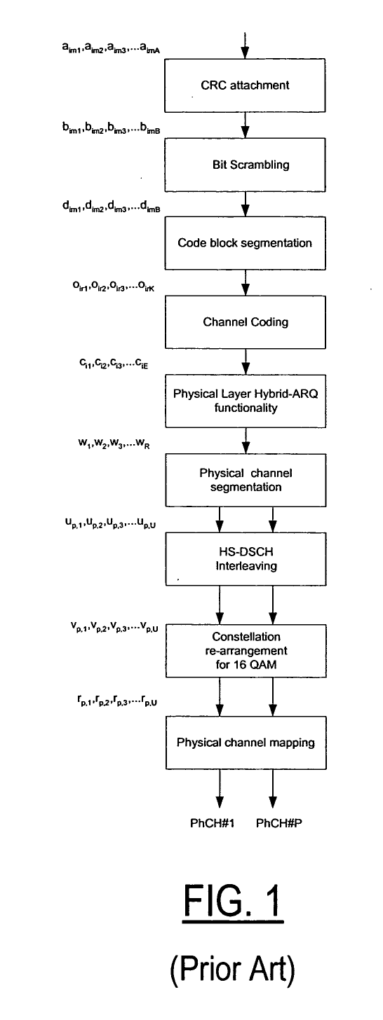

In coding for HS-DSCH for SISO, data arrives at the coding unit in the form of a maximum of one transport block once every transmission time interval (TTI). The transmission time interval is 2 ms in duration, and is mapped to a radio sub-frame of 3 slots. As shown in FIG. 1 and explained in section 4.5 of 3GPP TS 25.212, HS-DSCH coding—i.e. the overall channel coding for HS-DSCH as opposed to the source coding—can be viewed as including the following coding steps: CRC addition to each transport block; bit scrambling; code block segmentation; channel coding (turbo coding); hybrid ARQ processing; physical channel segmentation; interleaving for HS-DSCH; constellation re-arrangement for 16 QAM; and mapping to physical channels.

In the channel coding step, which for the HS-DSCH transport channel usually uses a rate ⅓ turbo coder, code blocks are delivered to the channel coding unit (module). The code blocks are denoted by oᵢᵣ₁,oᵢᵣ₂,oᵢᵣ₃, . . . , o_{irK}_{ᵢ}, where i is the TrCH number, r is the code block number, and Kᵢ is the number of bits in each code block. The number of code blocks on TrCH i is denoted by Cᵢ, and is usually only one for the HS-DSCH transport channel. After the channel coding for each code block, if Cᵢ is greater than 1, the encoded blocks are serially concatenated so that the block with lowest index r is output first from the channel coding unit; otherwise the encoded block is output from the channel coding unit as it is. The bits output are denoted by Cᵢ₁,Cᵢ₂,Cᵢ₃, . . . , C_{iE}_{ᵢ}, where i is the TrCH number and Eᵢ=CᵢYᵢ, where Yᵢ is the number of encoded bits.

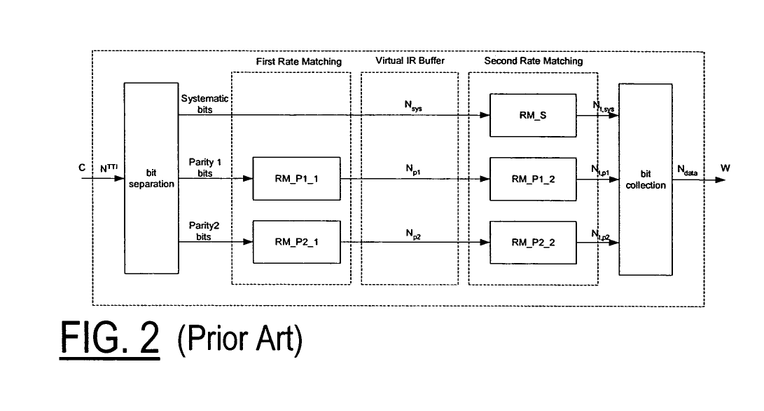

The hybrid ARQ functionality for HS-DSCH is shown in more detail in FIG. 2, and matches the number of bits at the output of the channel coder to the total number of bits of the HS-PDSCH (physical channel) set to which the HS-DSCH (logical/transport channel) is mapped. The hybrid ARQ functionality is controlled by the redundancy version (RV) parameters. The exact set of bits at the output of the hybrid ARQ functionality depends on the number of input bits, the number of output bits, and the RV parameters. (In FIG. 2, N^{TTI} is the number of coded bits in a TTI before rate matching, and the parity 1 and parity 2 bits are all of the first and second parity bits provided by the Turbo encoder in the N_{TTI} bits.)

As shown in FIG. 2, the hybrid ARQ functionality includes two rate-matching stages and a virtual IR (incremental redundancy) buffer. The first rate matching stage matches the number of input bits to the virtual IR buffer, information about which is provided by higher layers. If the number of input bits does not exceed the virtual IR buffering capability, the first rate-matching stage is transparent. The second rate matching stage matches the number of bits after first rate matching stage to the number of physical channel bits available in the HS-PDSCH set in the TTI.

As also shown in FIG. 2, the hybrid ARQ functionality also includes a HARQ bit collection module. The HARQ bit collection is achieved using a rectangular interleaver of size N_{row}×N_{col}. The number of rows and columns are determined from:
N_{row}=4 for 16QAM and N_{row}=2 for QPSK
N_{col}=N_{data}/N_{row}
where N_{data} is used as defined in section 4.5.4.3 of 3GPP TS 25.212. The N_{data} bits are provided to a physical channel segmentation module (FIG. 1) as w₁, w₂, w₃, . . . w_{R}, denoted as W in FIG. 2, where R is the number of bits input to the physical channel segmentation block. (The physical channel segmentation module is for when more than one HS-PDSCH is used, and then it divides the bits among the different physical channels.)

As further explained in 3GPP TS 25.212 section 5.4, the physical layer HARQ functionality for SISO (and according to the prior art) can be further decomposed as in FIG. 2, so as to culminate in a single HARQ bit collector (labeled simply “bit collection” in FIG. 2). The bits input to the HARQ functionality are separated into a set of systematic bits (information bits) and sets of non-systematic bits, i.e. redundancy bits, e.g. parity bits. Rate matching of the different sets of bits is then performed, and the rate-matched sets of bits are then provided to the HARQ bit collector, which provides as its output the input to the physical channel segmentation module.

Now as explained in section 5.2 of 3GPP TR (Technical Report) 25.876, in case of MIMO processing, i.e. in case of using several different transmit antennae and using per-antenna rate control (PARC) in order to implement FDD high-speed channels such as HS-DSCH, separately encoded (low-rate) data streams—that in combination convey a single high-rate data stream—are transmitted from each antenna with equal power but possibly with different data rates; further, the receiver estimates the channel quality and the information is fed back to the transmitter, which then determines the data rate to use for each antenna.

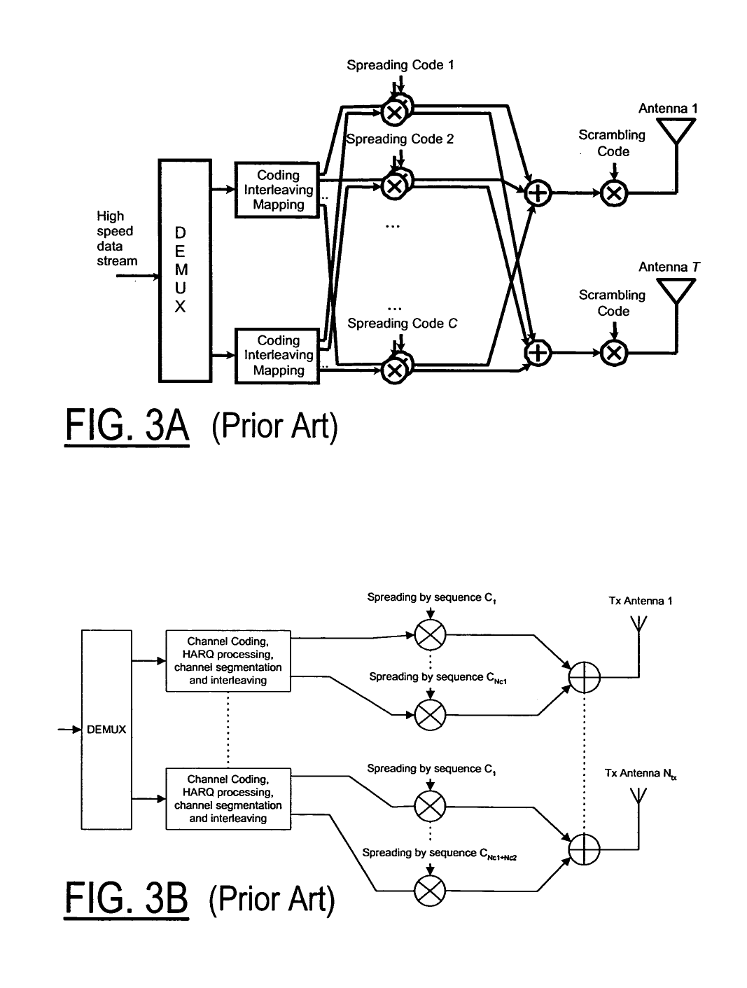

For HS-DSCH, the basic physical layer structure for PARC is illustrated in FIG. 3A, and from another perspective, also in FIG. 3B. In FIG. 3A, the “spreading”—i.e. modulation using a channelization code—is distinguished from the “scrambling.” In FIG. 3B, the “spreading” includes both modulation by a channelization code and also modulation by a scrambling code. As shown in FIGS. 3A and 3B, a block of data corresponding to a single high-rate data stream is de-multiplexed into several different low-rate streams, up to possibly as many as the number of transmit antennae. Each of these low-rate streams is turbo-encoded, interleaved, and mapped to either QPSK or 16QAM symbols (corresponding to the channel coding, HS-DSCH interleaving, and physical channel mapping blocks of FIG. 1, but also including in the coding step the processing performed by the physical layer HARQ functionality and the physical channel segmentation blocks of FIG. 1). Because different coding rates and symbol mappings can be used on each low-rate stream, the number of information bits assigned to each stream can be different. The low-rate streams are further de-multiplexed into a maximum of C sub-streams, where C is the maximum number of HS-PDSCH channels defined by the UE capability. The sub-streams are spread using distinct OVSF (orthogonal variable spreading factor) channelization codes also known as spreading codes, summed, and then modulated by a scrambling code. The resulting CDMA modulated low-rate streams are then transmitted from their associated antenna.

The number of assigned codes may differ from stream to stream (i.e. not all C codes may be used for a low-rate stream), and so the number of OVSF codes for the different (low-rate) streams may be different. If so, the codes for the antenna/low-rate stream with the most codes are assigned first, and then the codes for the other antennas are assigned, using a subset of the already assigned codes, in what is known as “code reuse” because the spreading codes (OVSF codes) are reused among the antennas.

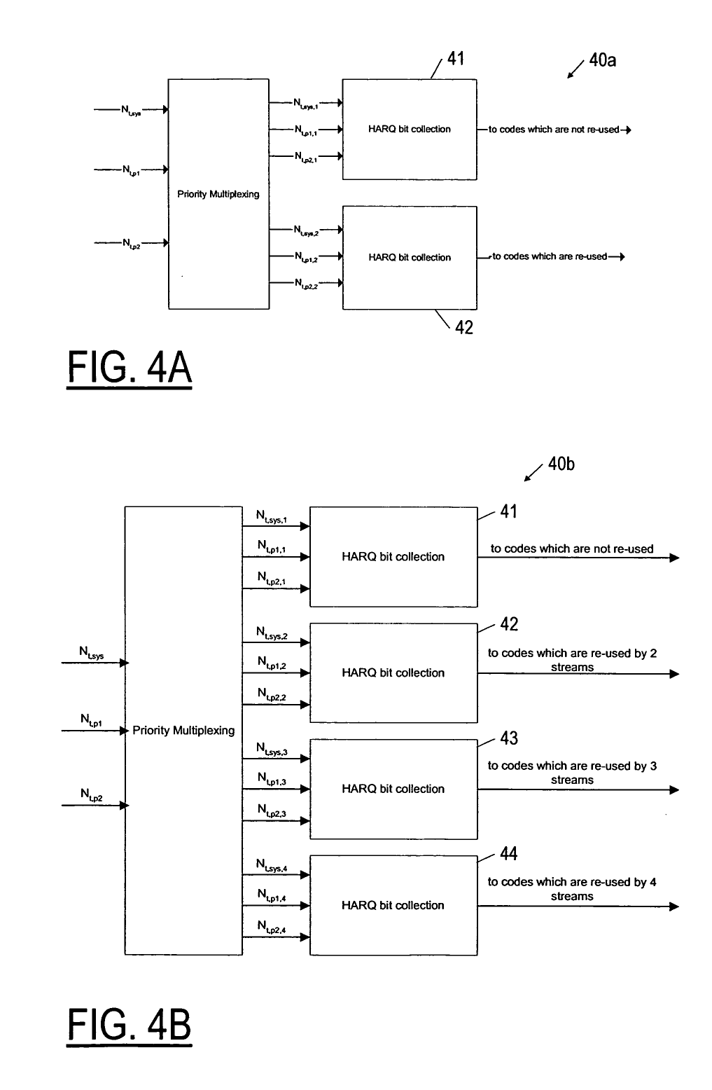

Now referring to FIG. 4A, according to the invention, for MIMO using two antennas, the single HARQ bit collector of FIG. 2 is replaced by two HARQ bit collectors 41 42 as sub-modules of a modified HARQ bit collector 40a—one sub-module bit collector 41 for providing bits to physical channels that do not reuse codes, and the other sub-module bit collector 42 for providing bits to physical channels reusing codes—and also a priority multiplexing module. Each (low-rate) stream in FIG. 3 (as opposed to a sub-stream) contains the coding chain as in FIG. 1, where the HARQ entity in FIG. 1 is modified according to FIG. 4A, but with a number of sub-module bit collectors typically the same as the number of (low-rate) streams/antennas of the MIMO system. As illustrated in FIG. 4B, a modified HARQ bit collector 40b is typically implemented in the case of four (low-rate) streams/antenna so as to have four sub-module bit collectors 41-44, one sub-module 41 for providing bits for codes not reused at all, one sub-module 42 for providing bits for codes reused by two streams/antennas, one sub-module 43 for providing bits for codes reused by three streams/antennas, and one sub-module 44 for providing bits for codes reused by four streams/antennas. (A modified HARQ bit collector according to the invention therefore typically has as an input the codes reused by two antennas, three antennas, and so on.)

The HARQ bit collector is basically a matrix where bits are written in and later read out in column-by-column order, systematic bits first, followed by redundancy bits (e.g. parity bits), as set out in 3GPP TS 25.212, section 4.5.4.4. In the invention, in the priority multiplexing module the bits that would otherwise be provided to the single HARQ bit collector of the prior art are instead segregated into multiple sets of bits, and each is then provided to a corresponding HARQ bit collector, as shown in FIG. 4A. Each of the HARQ bit collectors then provides a different bit stream as output (to the physical channel segmentation module shown in FIG. 1).

As an example, if a modified HARQ bit collector shown in FIG. 4A is used for say stream no. 3, transmitted on say antenna no. 3, and if antenna no. 3 uses some of the same codes as the other antenna but also uses some codes that are not reused (i.e. that are not also the same as the codes used by any of the other antenna), then both of the sub-module bit collectors (i.e. both the upper and lower sub-module bit collectors) of the modified HARQ bit collector would provide bits, but if all codes are reused, then only the bottom sub-module would provide bits. Now the object of the invention is to take into account the differences in channel quality—as indicated e.g. by SINR—for the different physical channels (i.e. each corresponding to a different antenna) e.g. when multi-streaming MIMO (BLAST type information multiplexing) is being used in a DS-CDMA system and the code allocation differs between the different streams of the multi-streaming MIMO, i.e. and the number of codes used per low-rate stream is different. The invention takes the differences into account in the interleaving, using e.g. the same interleaving strategy as set out in 3GPP TS 25.212 for 16-QAM in which the systematic bits after turbo encoding are allocated to code channels with a higher SINR (or other indicator of channel quality).

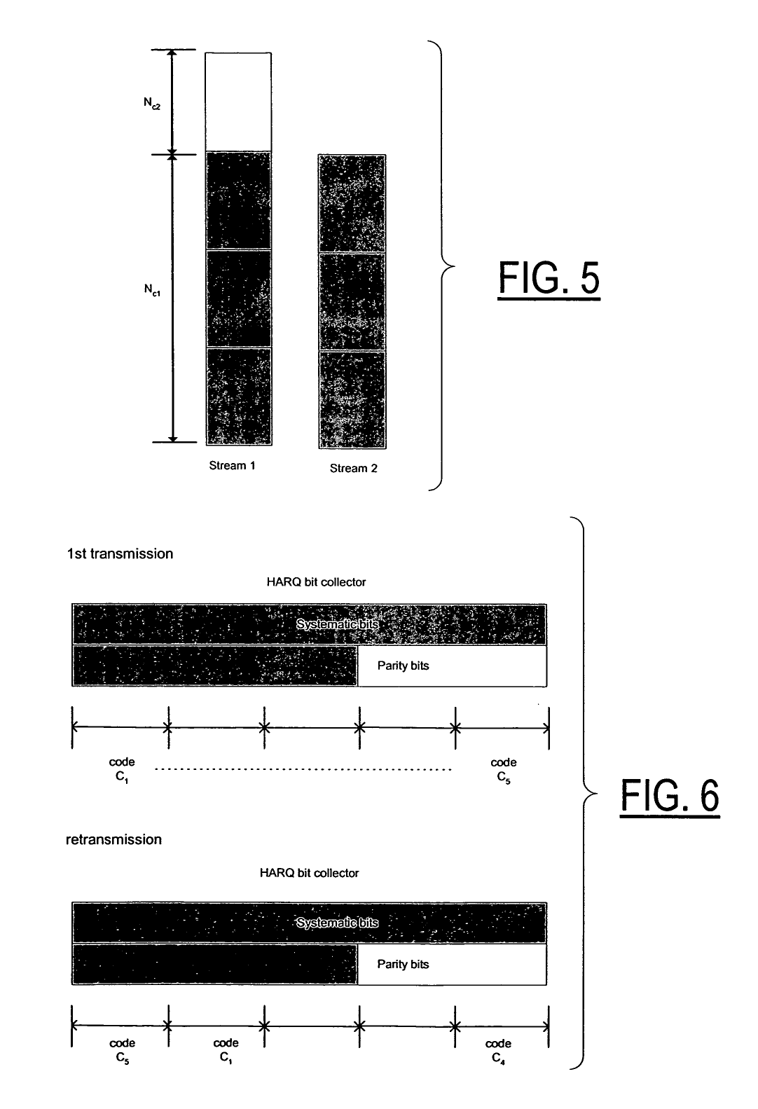

FIG. 5 is an example of code allocation, showing two (low-rate) bit streams—stream 1 and stream 2—being used in parallel, one transmitted by a first antenna, and the other by a second antenna. Streams 1 and 2 both use a same first set of N_{c1} channelization (spreading) codes—i.e. these codes are reused, and stream 1 alone also uses a second set of N_{c2} channelization codes. More specifically, in stream 1, M*480*N_{c1} bits are multiplexed to a code re-used channel and M*480*N_{c2} bits are multiplexed to channels without code re-use, where 480 is the number of bits per TTI, and where M is the number of bits per modulation symbol, e.g. 2 in QPSK or 4 in 16QAM. More than two bit streams can be used in parallel, and if so, the spreading code allocation can be refined further.

Now (and referring to both FIG. 4A and FIG. 5, so that stream 1 includes non-reused codes, but stream 2 does not) the bit allocation (to code channels) performed by a priority multiplexer according to the invention—which can work on blocks of bits or on a bit-by-bit basis—may be explained as using as constraints: M*480*N_{c2}=N_{t,sys,1}+N_{t,p1,1}+N_{t,p2,1} and M*480*N_{c1}=N_{t,sys,2}+N_{t,p1,2}+N_{t,p2,2} for stream 1, where the subscript “sys” indicates systematic bits, and the subscript “p” indicates parity (redundancy) bits, and N_{t,sys,1} is the total number of systematic bits to be allocated to the set of N_{c2} codes, N_{t,p1,1} and N_{t,p2,1} are the total number of parity bits for stream 1 to be allocated to the set of N_{c2} codes, N_{t,sys,2} is the total number of systematic bits to be allocated to the set of N_{c1} codes, and N_{t,p1,2} and N_{t,p2,2} are the total number of parity bits for stream 1 to be allocated to the set of N_{c1} codes. But, for stream 2, the N_{t,sys,1}=0, N_{t,p1,1}=0 and N_{t,p2,1}=0 since all the code channels are reused.

According to the invention, N_{t,sys,1}—the total number of systematic bits to be allocated to the set of N_{c2} non-reused codes—should be larger than N_{t,sys,2} if possible to achieve better protection for the systematic bits than for the redundancy/parity/non-systematic bits. (Additionally N_{t,p1,1} and N_{t,p2,1} can each be equal to or close to 0 if desired.) Since the (code) channels using the N_{c2} non-reused codes inherently have a higher channel quality (e.g. SINR), allocating bits so that N_{t,sys,1} is larger than N_{t,sys,2} is equivalent to the rule, provided by the invention, that the systematic bits after turbo encoding are allocated to code channels with a higher channel quality.

The above rule is effective in providing improved protection for the systematic bits at least in cases where the modulation alphabet/symbol constellation is such that all bits have the same SNR after demodulation. In other cases, interleaving the bits evenly in the code domain may result in the best performance.

In case of QPSK modulation, the parity bit allocation on non re-used channel may be 0 but with 16-QAM it is not necessarily desired since half of the bits in 16-QAM modulation have a worse SINR. In that case, a more even distribution might lead into better performance.

It may be assumed that relatively high coding rates and small code differences between the two (or more) bit streams of the invention are normally used. Therefore, at least some systematic bits will often be multiplexed to the code re-used channels as well.

Another possible implementation is to just select the channel segmentation order so that the first columns of the HARQ bit collector matrix are allocated to non-reused codes, since the first columns will contain more systematic bits if the coding rate is such that the number of systematic bits does not fit into the exact number of rows, i.e. if

$$⌊ \frac{{N}_{t , sys}}{{N}_{col}} ⌋ \neq 0 \qquad ( 1 )$$

where └ . . . ┘ represents the integer part of the indicated operation (and is sometimes called the floor function), N_{1,sys.} is the total number of systematic bits (to be conveyed by all the low-rate streams), and N_{col} is the number of columns of the HARQ bit collector matrix.

As indicated above, according to the invention, in order to control the bit allocation in the coding chain, the HARQ bit collector (FIG. 2) in the rate matching block of the physical layer HARQ functionality module (FIG. 1) is modified. The invention, though, encompasses implementing bit mapping/allocation to code channels according to the invention using either: the physical layer HARQ functionality module as described above; the channel segmentation unit; or the channel interleaver, i.e. each modified to perform the code mapping according to the invention.

The channel segmentation unit may be used to prioritize systematic bits as illustrated in FIG. 6. Assume that FIG. 6 corresponds to the case of five code channels and a QPSK modulated stream having coding rate larger than one half. Also assume that two code channels out of the five are not under code reuse. Bits are fetched and multiplexed from the original HARQ bit collector to the channel segmentation unit so that the first columns from the collector matrix end up allocated to code channel number one, and so on. According to the strategy defined above, code channels from number one to number two (left-hand side of the matrix in FIG. 6) should be allocated to codes that are not code reused, which may be done by the channel segmentation entity. To do so, the channel segmentation entity need only first start applying the code channels from the non-code-reused code channels and then proceed to spreading codes under code reuse. This will lead to a bit allocation where the systematic bits are allocated as intended if the condition in eq. (1) holds.

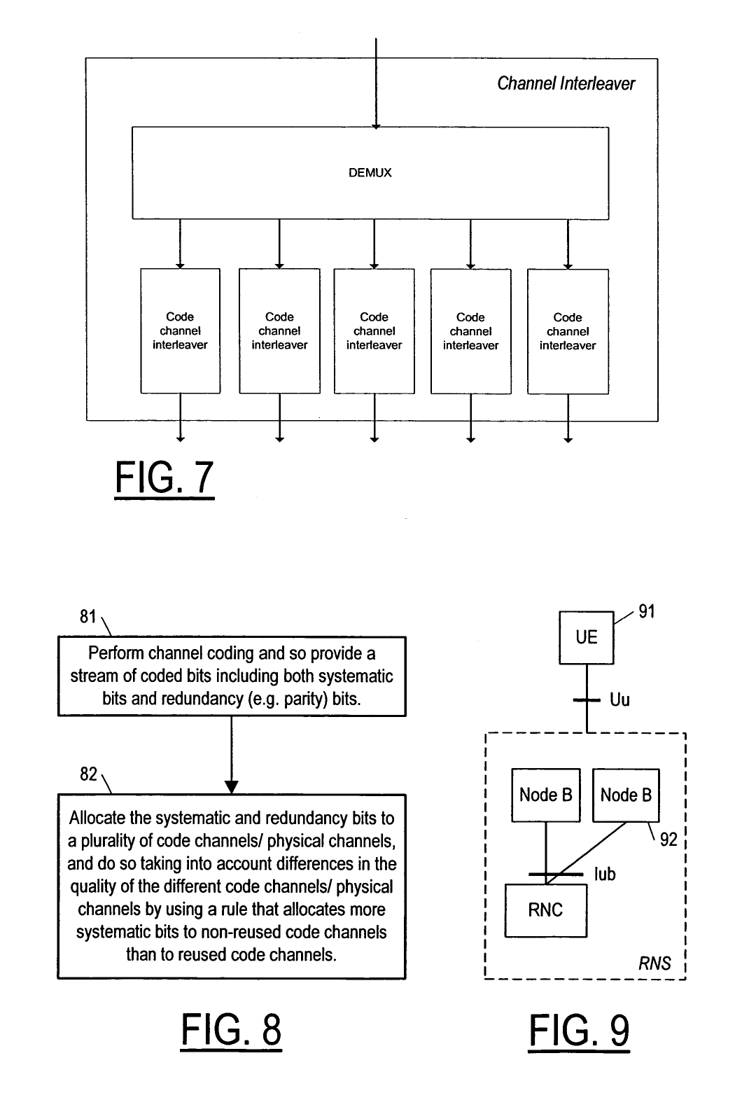

The channel interleaver unit may be used to prioritize systematic bits as illustrated in FIG. 7, illustrating a concatenated bit allocation and interleaving strategy. In fact, the cascade of the modified channel segmentation block and the original channel interleaver described above already implements an interleaving strategy. In general, though, one could have an interleaver performing the bit allocation all by itself, as in FIG. 7, with a demux module demultiplexing in the same way as the demux of FIG. 6, and with channel interleavers similar to those specified in the current 3GPP TS 25.212.

Note that during a HARQ retransmission, the invention allows changing the bit allocation, for example by alternating the code channel allocation. In other words, the code channel segmentation could work as in FIG. 6. By rotating/changing the code allocation as in FIG. 6 for example, the SINR differences averages out when the previous retransmission is combined with the latest one.

Besides alternating the code channel allocation, the invention also allows changing the bit allocation by redefining the systematic bit positions (but still per the invention, and so assigning as many as possible to non-reused code channels, and so on). But different bits would end up in different positions. This would eventually average out the differences between the bit SINR values. Although as already mentioned in the HARQ bit collector part, it may be in some situations advantageous to relax the systematic bit allocation strategy and allow parity bits also to be allocated to more favorable positions.

As should be clear from the above, the invention allows for code domain re-ordering during retransmission, i.e. so that the code domain bit allocation may be re-ordered during a HARQ retransmission of a failed packet. In a SISO system, such re-ordering does not affect performance but due to the varying SINR on the code re-used channel, code re-ordering may provide a gain in a MIMO system. One option for implementing code re-ordering is to simply rotate (or otherwise change) the code allocation (i.e. the bit-to-symbol mapping) in the channel multiplexing stage as in FIG. 6 or to redefine the priority multiplexing pattern.

The invention may be used even if a beam-forming type of transformation is used instead of a direct mapping of information streams to transmit antennas if code allocation between the streams may differ. The information streams need not all be targeted to the same user.

The code domain bit ordering strategy for information stream multiplexing type of MIMO scheme provided by the invention is applicable not only for PARC processing, but also for a PURC (Per Unitary Basis Stream User and Rate Control) processing for MIMO (PURC is an extension of PARC, and is explained at e.g. 3GPP WG1 document R1-030354), with or without beam-forming (if a different number of channelization codes on HS-DSCH may possibly be used). The scheme is easier to apply in case of QPSK modulation compared to 16-QAM.

As mentioned, the invention is of use in other than a 3GPP cellular communication system. More specifically, the invention is of use in case of any CDMA system using systematic channel encoding (having separate redundancy/parity bits and information bits), using a MIMO system with flexible code allocation where the encoded transmission is de-multiplexed for several code channels, and the number of code channels is possibly different for the different transmitted information streams, and the information streams may be mapped to the transmit antennas directly (PARC) or through a transformation such as beam-forming (PURC for example, although this scheme also has a more flexible user allocation). The principal objective of the invention is to transmit the systematic bits so that they have the best SNR, and this is done by selecting the code channels so that most of the systematic bits would use the code channel not under code re-use.

Referring now to FIG. 8, a method according to the invention—used in case of a MIMO transmission so as to provide a single (high-rate) data stream via a plurality of low-rate data streams each conveyed by a respective antenna, where each low-rate stream is modulated by a plurality of spreading codes (as illustrated in FIG. 3A or 3B)—is shown as including a step 81 of performing channel coding (typically done separately for each low-rate stream) and so providing a (low-rate) stream of coded bits including both systematic bits and redundancy bits (for protecting the systematic bits, the redundancy bits being parity bits in the case of turbo coding). The channel coding is as performed by the channel coding module of FIG. 1. In a next step 82, the systematic and redundancy bits are allocated to a plurality of code channels/physical channels taking into account differences in the quality of the different code channels/physical channels by using a rule that allocates more systematic bits to non-reused code channels than to reused code channels (i.e. the channels based on codes also used for channels conveyed by others of the antenna). The step 82 of bit allocation is performed by e.g. the modified HARQ bit collector 40 shown e.g. in FIG. 4A or 4B or of a corresponding module in case of implementing the invention so as to perform bit allocation (guided by the rule provided by the invention) using either a channel segmentation unit or a channel interleaver (see FIG. 1).

Referring now to FIG. 9, it should be understood and clear from the above description that the invention can be implemented in either a network element serving as at least part of a service access point of a radio access network, such as a Node B 92 of a Radio Network Subsystem (RNS) component of a radio access network (also including other RNSs, not shown), or as a component of a user equipment (UE) device 91 having a transceiver for coupling the user equipment device to a radio access network (via a service access point, such as the Node B 92).

It is to be understood that the above-described arrangements are only illustrative of the application of the principles of the present invention. Numerous modifications and alternative arrangements may be devised by those skilled in the art without departing from the scope of the present invention, and the appended claims are intended to cover such modifications and arrangements.

What is claimed is:

1. A method, comprising:
a step in which channel coding is performed for communication of systematic bits via a communication channel of a cellular communication system, the channel coding providing a stream of coded bits including both the systematic bits and also redundancy bits; and
a step of allocating the systematic and redundancy bits to a plurality of code channels including both reused and non-reused code channels, each code channel corresponding to a different physical channel;
wherein the bit allocation takes into account differences in the quality of the different physical channels by using a bit allocation rule that allocates more systematic bits to non-reused code channels than to reused code channels.

2. A method as in claim 1, wherein the stream for which the channel coding is performed is a stream in a plurality of streams that in combination convey a single higher-rate data stream, and the bit allocation is performed for each of the streams in the plurality of streams.

3. A method as in claim 2, wherein the bit allocation provides bits for code channels in the plurality of code channels not reused by any of the streams, and for code channels in the plurality of code channels reused by two of the streams, and for code channels reused by three of the streams, and so on.

4. A method as in claim 1, further comprising a physical layer HARQ processing step subsequent to the step of channel coding, and wherein the differences are taken into account in the physical layer HARQ processing step.

5. A method as in claim 1, further comprising an interleaving step subsequent to the step of channel coding, and wherein the differences are taken into account in the interleaving step.

6. A method as in claim 1, further comprising a physical channel segmentation step subsequent to the step of channel coding, and wherein the differences are taken into account in the physical channel segmentation step.

7. A method as in claim 1, wherein if there are more systematic bits than can be allocated to non-reused code channels so that non-allocated systematic bits remain after allocating as many of the systematic bits as possible to non-reused code channels, the rule allocates as many of the non-allocated systematic bits to the reused code channel expected to have the highest channel quality of the reused code channels.

8. A computer program product comprising a computer readable storage structure embodying computer program code thereon for execution by a computer processor, wherein said computer program code comprises instructions for performing a method including:
a step in which channel coding is performed for communication of systematic bits via a communication channel of a cellular communication system, the channel coding providing a stream of coded bits including both the systematic bits and also redundancy bits; and
a step of allocating the systematic and redundancy bits to a plurality of code channels including both reused and non-reused code channels, each code channel corresponding to a different physical channel;
wherein the bit allocation takes into account differences in the quality of the different physical channels by using a bit allocation rule that allocates more systematic bits to non-reused code channels than to reused code channels.

9. An apparatus, comprising:
means by which channel coding is performed for communication of systematic bits via a communication channel of a cellular communication system, the channel coding providing a stream of coded bits including both the systematic bits and also redundancy bits; and
means for allocating the systematic and redundancy bits to a plurality of code channels including both reused and non-reused code channels, each code channel corresponding to a different physical channel;
wherein the bit allocation takes into account differences in the quality of the different physical channels by using a bit allocation rule that allocates more systematic bits to non-reused code channels than to reused code channels.

10. An apparatus as in claim 9, wherein the stream for which the channel coding is performed is a stream in a plurality of streams that in combination convey a single higher-rate data stream, and the bit allocation is performed for each of the streams in the plurality of streams.

11. An apparatus as in claim 10, wherein the bit allocation provides bits for code channels in the plurality of code channels not reused by any of the streams, and for code channels in the plurality of code channels reused by two of the streams, and for code channels reused by three of the streams, and so on.

12. An apparatus as in claim 9, further comprising means for performing physical layer HARQ processing subsequent to the channel coding, and wherein the differences are taken into account in the means for performing the physical layer HARQ processing.

13. An apparatus as in claim 9, further comprising means for performing interleaving step subsequent to the channel coding, and wherein the differences are taken into account in the means for performing interleaving.

14. An apparatus as in claim 9, further comprising means for performing physical channel segmentation subsequent to the channel coding, and wherein the differences are taken into account in the means for performing physical channel segmentation.

15. An apparatus as in claim 9, wherein if there are more systematic bits than can be allocated to non-reused code channels so that non-allocated systematic bits remain after allocating as many of the systematic bits as possible to non-reused code channels, the rule allocates as many of the non-allocated systematic bits to the reused code channel expected to have the highest channel quality of the reused code channels.

16. An apparatus, comprising:
means by which channel coding is performed for communication of systematic bits via a communication channel of a cellular communication system, the channel coding providing a stream of coded bits including both the systematic bits and also redundancy bits; and
means for allocating the systematic and redundancy bits to a plurality of code channels including both reused and non-reused code channels, each code channel corresponding to a different physical channel;
wherein the apparatus is a component of a user equipment terminal having a transceiver for coupling the user equipment terminal to a radio access network; and
wherein the bit allocation takes into account differences in the quality of the different physical channels by using a bit allocation rule that allocates more systematic bits to non-reused code channels than to reused code channels.

17. An apparatus, comprising:
means by which channel coding is performed for communication of systematic bits via a communication channel of a cellular communication system, the channel coding providing a stream of coded bits including both the systematic bits and also redundancy bits; and
means for allocating the systematic and redundancy bits to a plurality of code channels including both reused and non-reused code channels, each code channel corresponding to a different physical channel;
wherein the apparatus is a component of a network element serving as at least part of a service access point of a radio access network; and
wherein the bit allocation takes into account differences in the quality of the different physical channels by using a bit allocation rule that allocates more systematic bits to non-reused code channels than to reused code channels.

18. A system, comprising: a radio access network including: network element serving as at least a part of a service access point of the radio access network, for providing a cellular communication signal; and a plurality of user equipment terminals each responsive to at least a portion of the cellular communication signal, wherein at least one of either the network element or one or more of the user equipment terminals includes an apparatus as in claim 9.
